(19) United States
(12) Patent Application Publication
(10) Pub. No.: US 2013/0212012 A1
(43) Pub. Date: Aug. 15, 2013

(54) System And Method For Mobile Electronic Purchasing

(71) Applicant: 34 Solutions, LLC, (US)

(72) Inventors: Thomas Cameron Doherty, Denver, CO (US); Carlin Dombush, Superior, CO (US); Anthony William Biondo, Tempe, AZ (US)

(73) Assignee: 34 Solutions, LLC, Carson City, NV (US)

(21) Appl. No.: 13/831,038

(22) Filed: Mar. 14, 2013

Related U.S. Application Data
(63) Continuation-in-part of application No. 12/905,755, filed on Oct. 15, 2010.

(51) Int. Cl. G06Q 20/32

(52) U.S. Cl. CPC G06Q 20/322
USPC 705/40

(57) ABSTRACT

A method for electronic purchasing via a mobile web-enabled smartphone or other communication device. A contacts list containing shipping addresses is stored on the smartphone. Initially, personal payment data, including credit card information, is entered into a smartphone, and sent to a payment gateway. The payment data in the smartphone is then redacted. The payment gateway sends a unique token to the smartphone for use in validating the current purchase transaction. In response to a request for credit card and shipping information from a merchant website for an item to be purchased, a specific one of the credit cards and a specific one of the shipping addresses is selected from a stored profile list. The token for the selected credit card and the shipping address are sent to the merchant website. The token and the selected shipping address are then sent from the merchant site to the payment gateway for validation.

### RELATED APPLICATIONS

This application is a continuation-in-part of U.S. patent application Ser. No. 12/905,755, filed on Oct. 15, 2011, which is incorporated by reference herein.

### BACKGROUND/PROBLEM TO BE SOLVED

Making an Internet purchase from a mobile phone typically requires that the purchaser manually enter data such as a credit card number and shipping information. For the purchaser, this becomes tedious when using multiple eCommerce systems and websites. For merchants, there is additional work associated with accepting credit card payments when using the mobile Internet. What is needed is a system for mobile web-enabled devices (e.g., ‘smartphones’) that allows both the user and the merchant to accomplish Internet-based purchasing tasks with less time and effort than that required by present purchaser-merchant interfaces.

### SUMMARY/SOLUTION

The present system stores multiple credit cards and uses previously entered data to simplify the data entry aspect of an online credit card transaction. Personal/payment information remains securely stored in the user's mobile phone. Furthermore, with the present system, merchants can leverage existing web assets and merchant accounts, instead of building an application for every type of ‘smartphone’. The customer's time to checkout is reduced to a relatively few clicks after an item is selected for purchase on a merchant's website. This system provides a more uniform experience on each user's smartphone across diverse merchants' websites.

In one embodiment, a contacts list containing shipping addresses is stored on the smartphone. Initially, personal payment data, including credit card information, is entered into a smartphone, and sent to a payment gateway. The payment data in the smartphone is then redacted. The payment gateway sends a unique token to the smartphone for use by the smartphone in validating the current purchase transaction.

In response to a request for credit card and shipping information from a merchant website for an item to be purchased, a specific one of the shipping addresses and credit cards is selected from a stored list. The selected shipping address and the token are then sent to the merchant website.

The token and transaction information is sent from the merchant website to the payment gateway, which validates the transaction, and a communication between the merchant and the smartphone indicates the final state of the transaction.

### BRIEF DESCRIPTION OF THE DRAWINGS

FIG. 1 is a diagram showing exemplary components of one embodiment of the present system;

FIG. 2 is a flowchart showing exemplary steps performed by the present system in one embodiment; and

FIG. 3 is a diagram showing exemplary data flow during operation of the present system.

### DETAILED DESCRIPTION

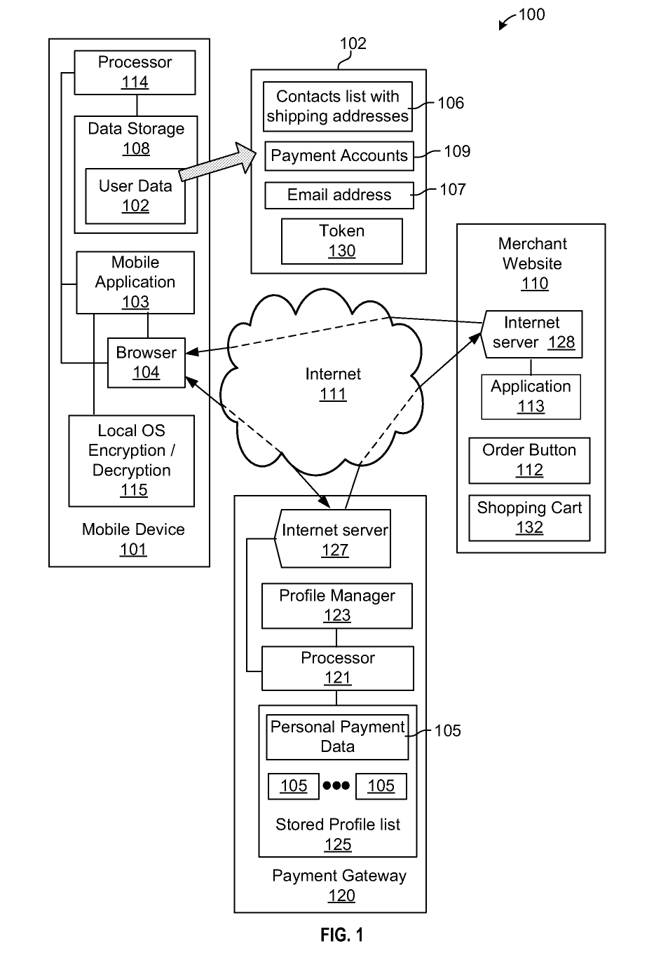

FIG. 1 is a diagram showing exemplary high-level components of the present system 100. As shown in FIG. 1, in an exemplary embodiment, the present system for mobile electronic purchasing 100 comprises a mobile web-enabled communication device (e.g., a ‘smartphone’) 101, a payment gateway 120, and a merchant website 110, which are interconnected via the Internet 111, using Internet servers 127 and 128.

Mobile device 101 includes a web browser 104, a transaction processing and communication application (“mobile application”) 103 executing on a processor 114, and a data storage area 108 containing user data 102. Merchant website 110 includes an order button 112 associated with a URL that opens an application 113 which communicates with a purchaser (hereinafter system user, or simply ‘user’) using mobile device 101. In one embodiment, a URL-based mechanism is used for communication between mobile device 101 and merchant website 110.

Payment gateway 120 includes a processor 121 that executes profile manager software 130, which provides the functionality for the payment gateway 120, as described herein. The functionality of each of the entities shown in FIG. 1 is explained in detail below.

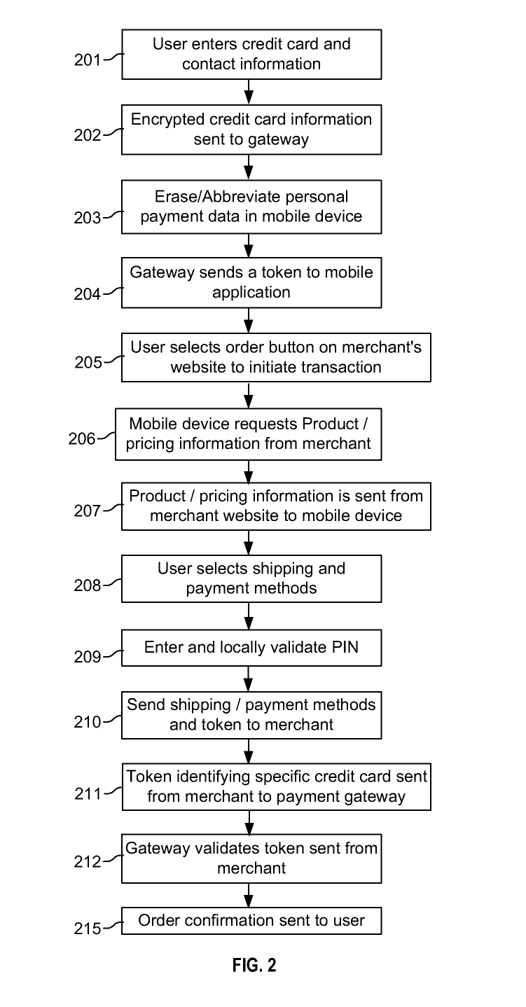

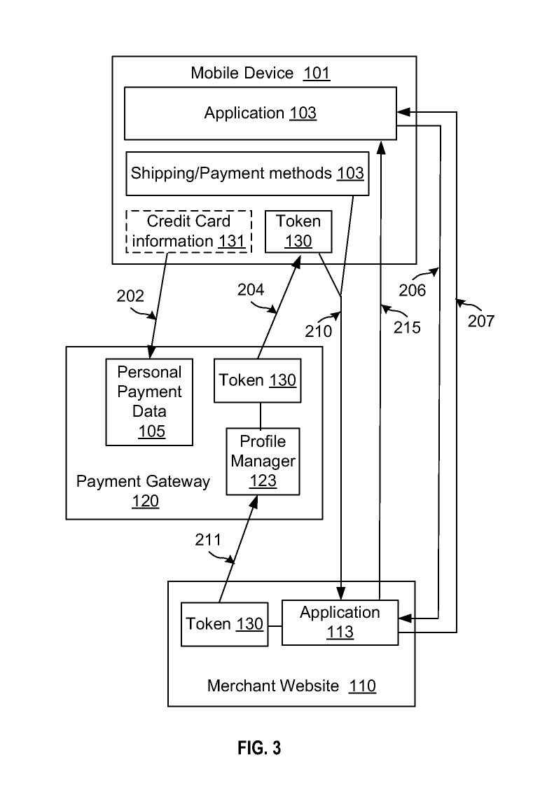

FIG. 2 is a flowchart showing steps performed by the present system in executing the purchase of an item with a credit (or debit) card using a mobile web-enabled communication device 101, such as a ‘smartphone’ (hereinafter ‘mobile device’ 101), in an exemplary embodiment. FIG. 3 is a diagram showing exemplary data flow during operation of the present system. The dataflow arrows shown in FIG. 3 are numbered to correspond to the steps shown in FIG. 2. Operation of the present system is best understood by viewing FIGS. 2 and 3 in conjunction with one another.

As shown in FIG. 2, at step 201, prior to using the present system to make a purchase, a user (using application 103) enters user data 102, including contact information comprising names and shipping addresses of one or more entities, personal payment (credit card) data 105, and an email address 107, and, optionally, the phone number for the mobile device 101. The names and shipping addresses are stored in a contacts list 106. A PIN (personal identification number) is also initially entered by the user and stored in mobile device 103 for user validation.

In an exemplary embodiment, personal payment data 105 includes credit (or debit) card information including card numbers and respective expiration dates for one or more credit cards. In one embodiment, contacts list 106 is the same file used by an application (e.g., browser 104) on mobile device 101 for determining email addresses used in sending email messages from the device.

At step 202, the personal payment data 105 is encrypted and sent securely to payment gateway 120, where it is stored in the gateway's stored profile list 124, together with the device phone number, and the email address 107 entered by the user. In one embodiment, mobile application 103 uses a local operating system service 115 (such as Apple® iOS Keychain or Core Data Service, where the mobile device is an iPhone® or iPad®) to encrypt information sent from the mobile device 101. The phone number may be used in conjunction with the personal payment data 105 for verification of the specific mobile device 103 that is used in a transaction.

At step 203, personal payment data 105 stored in the mobile device is abbreviated or redacted. That is, mobile application 103 effectively erases all payment data 105 stored in the mobile device except for the payment (credit card) type and the last 4 digits of the card account number, i.e., “AMEX ending in 4532”.The redacted user payment account data is saved in payment accounts area 109 in user data area 102.

At step 204, in response to receiving personal payment data 105 (at step 102) payment gateway 120 sends a token 130 to mobile application 103, which receives and stores the token in user data storage 102. This token 130 is used to identify a specific credit card in future transactions. In one embodiment, each token 130 comprises an account ID that is unique for each credit card, generated by profile manager 123.

To make a purchase, the user first displays a web page on a merchant's website using web browser 104 on mobile device 101. After the user selects the item(s) to be purchased by placing the item(s) in an order list, such as a ‘shopping cart’ 132 or the like, an order button 112 on the web page is selected (‘clicked on’) to initiate the purchasing transaction, at step 205. Merchant website 110 uses application 113 to communicate with mobile device 101. In an exemplary embodiment, application 113 is specifically adapted to send and receive product and purchase information to/from application 103 in mobile device 101.

Item information including the item price, merchant name, and item description of the selected item is then requested by the mobile device, at step 206, and the requested information is sent from merchant website 110 to mobile device application 103, at step 207.

At step 208, the user selects a shipping method including the shipping address, and a payment method (the specific credit/debit card to be used for the transaction) in response to prompt screens on device 101 generated by mobile application 103. The shipping method selection is made from previously entered shipping address data (from the user's contacts list 106), and a particular credit or debit card is selected from a list of cards for which data was previously entered and stored in payment accounts file 109. At step 209, the user completes the transaction by entering the appropriate PIN, which is validated locally by mobile application 103.

At step 210, mobile application 103 then sends the shipping method to merchant website 110, along with the token 130 (received/stored in step 204) identifying the specific credit card selected by the user of the mobile device. At step 211, merchant website 110 sends the token 130 and transaction information to profile manager 123 in payment gateway 120 for validation.

At step 212, the transaction is validated, by gateway 120, against the token 130 sent previously to the mobile device, and the gateway 120 processes the transaction. At step 215, a transaction ‘success’ or ‘failure’ message is sent from the merchant website 110 to the mobile application 103, where the message is displayed to the user.

Having described the invention in detail and by reference to specific embodiments thereof, it will be apparent that modifications and variations are possible without departing from the scope of the invention defined in the appended claims. More specifically, it is contemplated that the present system is not limited to the specifically-disclosed aspects thereof.

What is claimed is:

1. A method for electronic purchasing via a mobile web-enabled communication device including an Internet browser, the method comprising:
creating a contacts list, stored on the mobile device, containing at least one shipping address;
creating a payment file containing credit card information including a card number for at least one credit card;
sending the payment file to a payment gateway;
redacting the payment file in the mobile device by deleting certain information therein to yield a partial card number for each said credit card;
sending, from the payment gateway, a token containing an identifier, specific to the credit card, to the mobile device in response to receiving the payment file from the mobile device;
sending, from the mobile device to a merchant website, the token, transaction information. and a specific said shipping address from the contacts list; and
sending the specific shipping address and the token, from the merchant website to the payment gateway for transaction validation.

2. The method of claim 1, wherein the contacts list is the file used for determining email addresses used in sending email messages from the device.

3. A method for electronic purchasing via a mobile web-enabled communication device including an Internet browser, the method comprising:
creating a contacts list, stored on the mobile device, containing at least one shipping address;
creating a payment file containing credit card information including a card number for a credit card;
sending the payment file to a payment gateway;
redacting the payment file in the mobile device by deleting certain information therein to yield a partial card number for each said credit card;
sending a token containing an identifier, specific to the credit card, to the mobile device in response to receiving the payment file from the mobile device;
displaying, via the browser, a merchant website including a web page displaying an order button;
placing the item to be purchased in an order list on the web page;
selecting the order button to cause item information including the name and price of a selected item to be purchased to be sent from the merchant website to the mobile device;
in response to receipt of the item information from the merchant website:
selecting a specific said shipping address and a specific said credit card and from the contacts list and the payment file, respectively;
sending the specific shipping address and the token from the mobile device to the merchant website; and
sending the selected shipping address, and the token from the mobile device to the merchant website for order processing.

4. The method of claim 3, wherein the contacts list is the file used for determining email addresses used in sending email messages from the device.
